(19) United States
(12) Patent Application Publication
(10) Pub. No.: US 2005/0207836 A1
(43) Pub. Date: Sep. 22, 2005

(54) Quick coupler system

(76) Inventor: Michael Melander, Diamond Bar, CA (US)

Correspondence Address: FOLEY & LARDNER, 321 NORTH CLARK STREET, SUITE 2800, CHICAGO, IL, 60610-4764, US

(21) Appl. No.: 10/802,158

(22) Filed: Mar. 17, 2004

(51) Int. Cl. F16D 1/00

(52) U.S. Cl. 403/324

(57) ABSTRACT

A coupler system comprising a coupler and an attachment member for quickly and easily connecting a tool to a piece of machinery. The coupler includes first and second coupler side walls joined by a lower coupler wall, the first and second side walls defining a primary axis therebetween. A plurality of coupler bosses are attached to the lower coupler wall, the plurality of coupler bosses being positioned substantially in-line with each other along the primary axis. A plurality of transverse members are coupled to the first and second coupler side walls. The attachment member includes first and second attachment side walls, each of the first and second attachment side walls including a plurality of attachment member slots sized and positioned to receive the plurality of transverse members. An attachment member boss is fixedly secured to the attachment member. A lock pin sized to be accepted by the plurality of coupler boss members and the attachment boss member, wherein when the plurality of transverse members are positioned within the plurality of attachment member slots, the plurality of coupler boss members and the attachment boss member align to accept the lock pin, the lock pin securing the position of the attachment member relative to the coupler.

### FIELD OF THE INVENTION

The present invention relates generally to coupling devices.

### BACKGROUND OF THE INVENTION

Quick couplers have been widely used with excavating equipment, such as hydraulic excavators or backhoes, to allow individual pieces of equipment to be used with a variety of tools, e.g., different buckets, grapples and the like, without extended downtime for changing tools. For example, one conventional quick release hitch for attaching an implement to the arm of a hydraulic excavator comprises a pair of pivoted links, with each link having a jaw for engaging a pin on the implement. The links can be jack-knifed to engage or disengage the implement; and locking structures are provided for locking the links together when the implement has been engaged, with the locking structure preferably being a rotatable cam and/or over-center mechanism.

Conventional quick couplers typically include a pair of spaced parallel plates, with the plates defining holes for fixed attachment of the coupler to the end of a backhoe or other piece of equipment. The plates define a first slot facing generally forward to engage a first pin on the bucket or tool, and a second slot, facing generally downward (i.e., disposed at 90 degrees to the first slot) to engage a second pin on the bucket or tool. In operation, the first pin is engaged in the first slot. The coupler is then rotated about the longitudinal axis of the first pin to engage the second pin in the second slot. The coupler and tool are thereafter secured together by engagement, e.g., of a coupler gate with the second pin. This coupler gate is typically pivotally mounted to a pin on the coupler such that it pivots about a horizontal axis parallel to the longitudinal axes of the first and second slots/pins. These conventional couplers can be rendered virtually unusable by a relatively small degree of wear in the slots.

Although moderately effective, conventional coupler systems include a number of drawbacks. For example, most conventional coupler systems currently available require the use of tools such as wrenches to remove the attachment from the coupler. This both adds complexity and difficulty to the assembly and disassembly processes, as well as lengthening the amount of time required to remove and/or replace an implement. Additionally, many conventional couplers utilize a “blank hook” design that includes a wedge that presses the coupler to the attachment. The wedge is part of the coupler and forces the attachment to the coupler by tightening bolts that pass through the wedge. Once tight, the wedge acts to hold the attachment to the coupler. However, it would be advantageous for the coupler system to not include a wedge at all.

### SUMMARY OF THE INVENTION

According to the general principles of the present invention, a quick coupler is disclosed for attaching an attachment to a machine such as an excavator. The coupler includes a plurality of substantially parallel pins that each run between a pair of substantially parallel sidewall plate members. The pins are connected to the sidewall plate members by a plurality of bosses. The attachment also includes a pair of substantially parallel plates, each of which includes a plurality of slots for selective engagement with the plurality of bosses. The coupler is latched to the attachment by a lock pin that is secured to the coupler by the use of a plurality in-line bosses and secured to the attachment by a boss. This is placed in-line with the plurality of in-line bosses on the coupler.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1(a) is a perspective view of an unattached bucket and an excavator arm with an improved quick coupler according to one embodiment of the present invention.

FIG. 1(b) is another perspective view of an unattached bucket and improved quick coupler without an excavator shown.

FIGS. 2(a)-2(c) are side elevation views of the quick coupler of FIG. 1, illustrating the attachment of the tool to the quick coupler.

FIG. 3 is a front end view illustrating the quick coupler of FIG. 1 with the attachment in the latched position.

FIG. 4 is a side elevation view that shows a quick coupler according to one embodiment of the present invention.

### DETAILED DESCRIPTION OF THE INVENTION

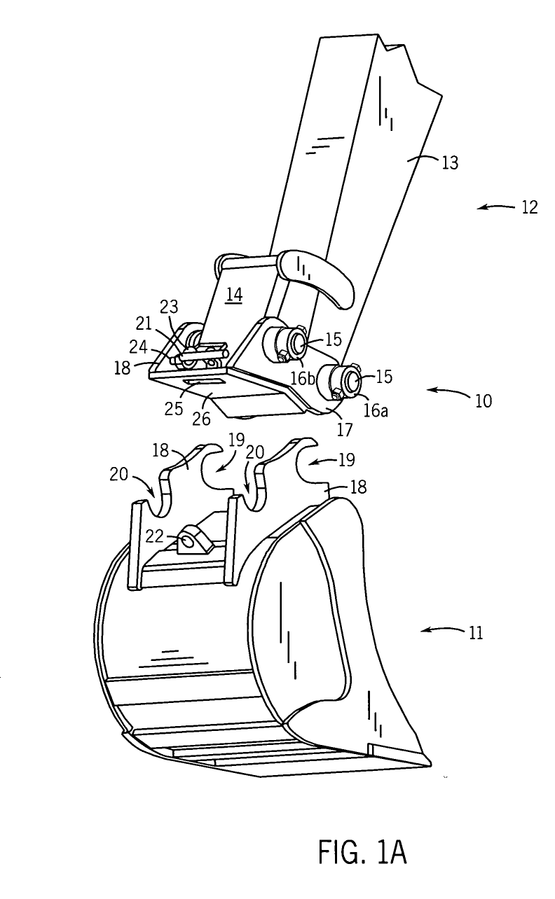

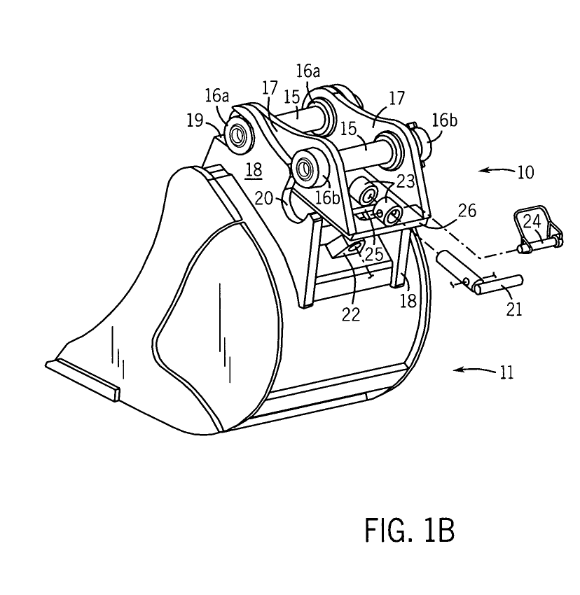

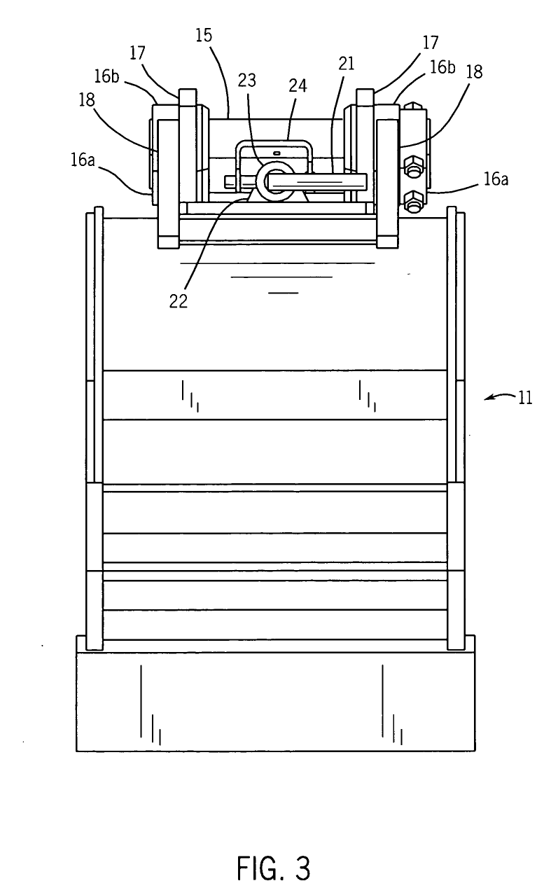

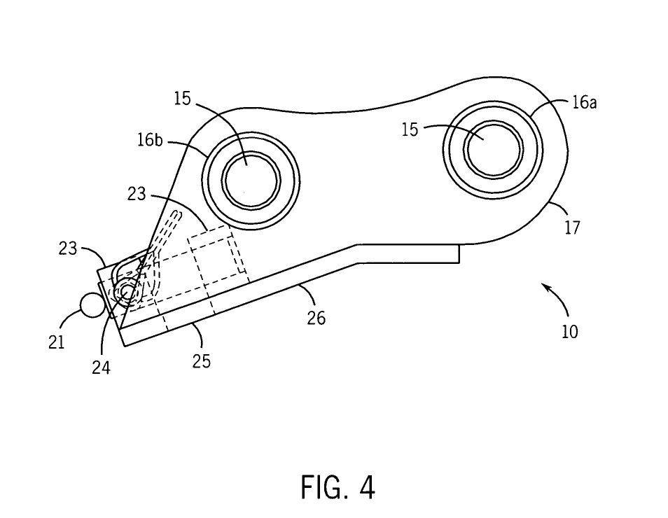

An improved quick coupler constructed in accordance with the principles of the present invention is shown and described in FIGS. 1-4. A coupler 10 is securely attached to an arm assembly of an excavator 12. An implement 11 is shown in FIG. 1(a) but is not attached to the coupler 10. The quick coupler 10 permits attachment of a range of tools, including but not limited to buckets, grapples and the like, to a backhoe or other excavator or similar machine.

The coupler 10 is pivotally attached to an excavator dipper stick 13 and a link 14 by a plurality of pins 15. The plurality of pins 15 run through bosses 16 on the coupler 10 and pivot holes in the dipper stick 13 and the link 14. According to a preferred embodiment of the invention, the coupler 10 includes a pair of pins 15. However it is possible that a different number of pins 15 could be used. The coupler 10, according to one embodiment of the invention, comprises a pair of parallel plates 17 including a plurality of generally parallel front and rear coupler pin bosses 16a and 16b into which the plurality of pins 15 are mounted.

The attachment 11 includes a plurality of generally parallel plates 18 on the top end thereof. The plurality of generally parallel plates 18 on the attachment 11 each include a forward slot 19 and a rearward slot 20. The forward slot 19 of each of the parallel plates 18 captures the front coupler pin bosses 16a that attaches to the dipper stick 13. The rearward slot 20 of each of the parallel plates 18 captures the rear coupler pin boss 16b that attaches to the link 14.

The coupler 10 is secured to the attachment 11 by way of a lock pin 21. The lock pin 21 secures the coupler 10 by sliding through a plurality of in-line bosses 23 located on the coupler, as well as sliding through an attachment boss 22 on the attachment that aligns with the plurality of in-line bosses 23 on the coupler 10. The lock pin 21 is secured in place by way of a retainer pin 24. The retainer pin 24 latches the lock pin 21 to the boss 23 on the coupler 10. The attachment boss 22 is aligned with the plurality of in-line bosses 23 on the coupler 10 by means of a slot 25 located in the base plate 26 of the coupler 10, with the attachment boss 22 passing through the slot 25.

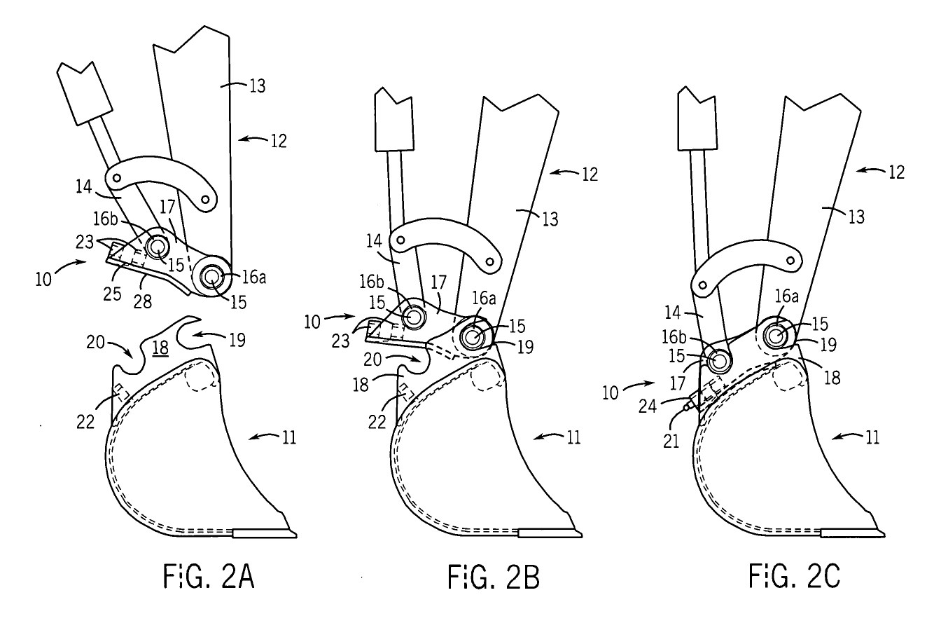

Referring to FIGS. 2(a)-2(c), the operation of the coupler 10 of FIG. 1 is shown in three stages of connection to an attachment 11. FIG. 2(a) shows the coupler 10 attached to the arm of an excavator 12. In FIG. 2(a), the attachment 11 is shown ready to be coupled to the coupler 10. FIG. 2(b) shows the pin boss 16b of the coupler 10 engaged in the forward slot 19 of the attachment 11. From this point, the coupler 10 is rotated on the excavator dipper stick 13 into the position shown in FIG. 2(c). FIG. 2(c) shows the link boss 16b of the coupler 10 latched into the rear slot 20 of the attachment. In this position, the bosses 23 on the coupler 10 are inline with the boss 22 on the attachment 11. The lock pin 21 is inserted through the bosses 23 on the coupler 10 and the boss 22 on the attachment 11. The lock pin 21 is secured to the coupler 10 by the retainer pin 24.

A number of embodiments of the invention have been described. Nevertheless, it will be understood by those skilled in the art that various modifications may be made without departing from the spirit and scope of the invention. For example, rather than having the lock pin 21 manually actuated, the lock pin 21 may be actuated by remote control, e.g., from the cab of the excavator, using hydraulic or pneumatic cylinders to move the latch lever. Many changes and modifications within the scope of the present invention may therefore be made without departing from the spirit of the invention, and the invention includes all such changes and modifications.

1. A system for coupling a tool to a machine, comprising:
a coupler body comprising:
first and second opposed coupler sidewalls,
a plurality of transverse members, each of which is coupled to the first and second opposed side walls, and
a first coupler boss member positioned between the first and second opposed side walls, the first coupler boss member having a principal axis running substantially parallel to the first and second opposed coupler side walls;
an attachment member comprising:
first and second opposed attachment member sidewalls, each of the first and second opposed attachment member sidewalls defining a plurality of attachment member slots sized and positioned to receive the plurality of transverse members, and
an attachment boss member positioned between the first and second opposed attachment member sidewalls, the attachment boss member having a principal axis running substantially parallel to the first and second opposed attachment member side walls; and
a lock pin sized to be accepted by the first coupler boss member and the attachment boss member,
wherein when the plurality of transverse members are positioned within the plurality of attachment member slots, the first coupler boss member and the attachment boss member align to accept the lock pin, the lock pin securing the position of the attachment member relative to the coupler body.

2. The system of claim 1, further comprising a retainer pin, the retainer pin securing the lock pin in place when the lock pin is securing the position of the attachment member relative to the coupler body.

3. The system of claim 2, further comprising a second coupler boss member positioned between the first and second opposed side walls, the second coupler boss member being substantially in line with the first coupler boss member and sharing the same principal axis, the second coupler boss member being sized to accept the lock pin.

4. The system of claim 3, wherein each of the plurality of transverse members comprises:
a pin extending between the first and second opposed coupler sidewalls;
a first pin boss for operatively connecting the pin to the first coupler sidewall; and
a second pin boss for operatively connecting the pin to the second coupler sidewall.

5. The system of claim 4, wherein each of the first and second pin bosses for each of the plurality of transverse members contact one of the plurality of attachment member slots when the position of the attachment member to relative to the coupler body.

6. The system of claim 3, wherein the coupler further comprises a coupler slot between the first and second coupler boss members, permitting the attachment boss member to be positioned between and aligned with the first and second coupler boss members.

7. The system of claim 1, wherein the attachment member is coupled to a bucket.

8. The system of claim 1, wherein the attachment member is coupled to a grapple.

9. A coupler system for coupling a tool to an attachment member including first and second attachment side walls, each of which include a plurality of attachment member slots sized and positioned to receive the plurality of transverse members, with an attachment member boss fixedly secured to the attachment member, the coupler system comprising:
a coupler including first and second coupler side walls joined by a lower coupler wall, the first and second side walls defining a primary axis therebetween;
a plurality of coupler bosses fixedly attached to the lower coupler wall, the plurality of coupler bosses being positioned substantially in-line with each other along the primary axis;
a plurality of transverse members each coupled to the first and second coupler side walls; and
a lock pin sized to be accepted by the plurality of coupler boss members and the attachment boss member,
wherein when the plurality of transverse members are positioned within the plurality of attachment member slots, the plurality of coupler boss members and the attachment boss member align to accept the lock pin, the lock pin securing the position of the attachment member relative to the coupler.

10. The coupler system of claim 9, wherein the plurality of coupler boss members consist of two coupler boss members.

11. The coupler system of claim 10, wherein the coupler further includes a coupler slot between the coupler boss members sized and positioned such that the attachment boss member can fit through the coupler slot to align with coupler boss members.

12. The coupler system of claim 9, wherein each of the plurality of transverse members comprises:
a pin extending between the first and second coupler sidewalls;
a first pin boss for operatively connecting the pin to the first coupler sidewall; and
a second pin boss for operatively connecting the pin to the second coupler sidewall.

13. The coupler system of claim 12, wherein each of the first and second pin bosses for each of the plurality of transverse members contact one of the plurality of attachment member slots when the position of the attachment member is relative to the coupler.

14. The coupler system of claim 9, further comprising a retainer pin, the retainer pin securing the lock pin in place when the lock pin is securing the position of the attachment member relative the coupler.

15. The coupler system of claim 9, wherein the attachment member is coupled to a bucket.

16. The coupler system of claim 9, wherein the attachment member is coupled to a grappler.

17. A method of removably coupling a tool to a machine, comprising the steps of:
providing a coupler comprising:
first and second coupler side walls joined by a lower coupler wall, the first and second side walls defining a primary axis therebetween,
a plurality of coupler bosses fixedly attached to the lower coupler wall, the plurality of coupler bosses being positioned substantially in-line with each other along the primary axis, and
a plurality of transverse members each coupled to the first and second coupler side walls;
providing an attachment member comprising:
first and second attachment side walls, each of the first and second attachment side walls comprising a plurality of attachment member slots, and
an attachment member boss positioned between the first and second attachment side walls;
mating the plurality of transverse members with the plurality of attachment slots; and
inserting a lock pin through the plurality of couplers and the attachment member boss, securing the position of the attachment member relative to the coupler.

18. The method of claim 17, further comprising the step of securing the lock pin with a retainer pin.

19. The method of claim 17, wherein the attachment boss member passes through a coupler slot between the coupler boss members in order to align with the coupler boss members when the plurality of transverse members are mated with the plurality of attachment slots.

20. The method of claim 17, wherein each of the plurality of transverse members comprises:
a pin extending between the first and second coupler sidewalls;
a first pin boss for operatively connecting the pin to the first coupler sidewall; and
a second pin boss for operatively connecting the pin to the second coupler sidewall.
